(19) United States
(12) Patent Application Publication
(10) Pub. No.: US 2018/0346012 A1
(43) Pub. Date: Dec. 6, 2018

(54) STEERING DEVICE AND ASSEMBLING METHOD FOR STEERING DEVICE

(71) Applicant: NSK LTD., Tokyo (JP)

(72) Inventor: Yoshifumi KUROKAWA, Maebashi-shi, Gunma (JP)

(73) Assignee: NSK Ltd., Tokyo (JP)

(21) Appl. No.: 15/775,618

(22) PCT Filed: Nov. 10, 2016
(86) PCT No.: PCT/JP2016/083306

§ 371 Date: May 11, 2018

(30) Foreign Application Priority Data
Nov. 12, 2015 (JP) 2015-221901
Dec. 24, 2015 (JP) 2015-251205

(51) Int. Cl. B62D 1/184; B62D 1/189

(52) U.S. Cl. CPC B62D 1/184; G01B 5/02; B62D 1/189

(57) ABSTRACT

An adjustment rod is inserted in a width direction through displacement-side through holes and one pair of vehicle body-side through holes. One pair of pressing parts are disposed at positions where both end parts of the adjustment rod protrude from respective outer surfaces of one pair of support plate parts. An adjustment lever is secured to the adjustment rod. With the distance between the one pair of pressing parts being reduced by turning the adjustment lever in a predetermined direction, the amount of tightening of an adjustment nut serving as one of the pressing members is adjusted while checking an axial force applied to the adjustment nut. The tightening amount adjustment of the adjustment nut is completed with the checked axial force remaining in a predetermined range.

### TECHNICAL FIELD

The present invention relates to a steering device including a position adjustment mechanism capable of adjusting a position of a steering wheel in a front and rear direction, in correspondence to a physique and a driving posture of a driver.

### RELATED ART

In the related art, a steering device for automobile as disclosed in Patent Document 1, for example, has been known and is formed as shown in FIG. 23. In the configuration of FIG. 23, the steering device is configured to transmit rotation of a steering wheel 1 to an input shaft 3 of a steering gear unit 2, and to push and pull a pair of left and right tie-rods 4, 4 in association with rotation of the input shaft 3, thereby applying a steering angle to wheels (front wheels). The steering wheel 1 is supported and fixed to a rear end portion of a steering shaft 5. The steering shaft 5 is rotatably supported to a cylindrical steering column 6 with being inserted in the steering column 6 in an axial direction. Also, a front end portion of the steering shaft 5 is connected to a rear end portion of an intermediate shaft 8 via a universal joint 7. A front end portion of the intermediate shaft 8 is connected to the input shaft 3 via a separate universal joint 9. Meanwhile, in the shown example, an electric assist device configured to reduce a force, which is necessary to operate the steering wheel 1, by using an electric motor 22 as an auxiliary power source is also incorporated.

Meanwhile, in the specification and the claims, the front and rear direction, the right and left direction (width direction) and the vertical direction indicate the front and rear direction, the right and left direction (width direction) and the vertical direction of a vehicle, unless otherwise specified.

Also, the shown structure includes a tilt mechanism for adjusting a vertical position (tilt position) of the steering wheel 1 and a telescopic mechanism for adjusting a position in a front and rear position, in correspondence to a physique and a driving posture of a driver. In order to configure the tilt mechanism, the steering column 6 is supported to a vehicle body 10 so that it can be swingably displaced about a pivot 11 arranged in a width direction. Also, in order to configure the telescopic mechanism, the steering column 6 has such a structure that an outer column 12 arranged at a rear side and an inner column 13 arranged at a front side are combined to be expanded and contracted in a telescopic shape, and the steering shaft 5 has such a structure that an outer shaft 14 arranged at a rear side and an inner shaft 15 arranged at a front side are combined by spline engagement or the like so as to transmit torque and to be expanded and contracted.

Also, a displacement bracket 16 fixed to a part near a rear end of the outer column 12 is supported to a support bracket 17 supported to the vehicle body 10 so that it can be displaced in the vertical direction and the front and rear direction. Also, the displacement bracket 16 is formed with a long hole 18 for telescopic adjustment extending in an axial direction of the outer column 12, which is a telescopic position adjustment direction. Also, the support bracket 17 has a pair of support plate parts 19 configured to sandwich the displacement bracket 16 from both sides in the width direction. Both the support plate parts 19 are formed at portions, which align each other, with long holes 20 for tilt adjustment extending in the vertical direction, which is a tilt position adjustment direction. In general, both the long holes 20 for tilt adjustment have a circular arc shape of which a center is the pivot 11. Also, an adjustment rod 21 is inserted in both the long holes 20 for tilt adjustment and the long hole 18 for telescopic adjustment. A pair of pressing parts is provided at portions, which are both end portions of the adjustment rod 21 and protrude from outer surfaces of both the support plate parts 20 in the width direction. An interval between both the pressing parts can be expanded and contracted by an expansion/contraction mechanism configured to operate on the basis of an operation of an adjustment lever.

When adjusting a position of the steering wheel 1 in the vertical direction or in the front and rear direction, the adjustment lever is rotated in a predetermined direction to expand the interval between both the pressing parts. Thereby, a frictional force that is applied between inner surfaces of both the support plate parts 19 in the width direction and both outer surfaces of the displacement bracket 16 in the width direction and a frictional force that is applied between inner surfaces of both the pressing parts in the width direction and outer surfaces of both the support plate parts 19 in the width direction are reduced. In this state, a position of the steering wheel 1 is adjusted within a range in which the adjustment rod 21 can be displaced in both the long holes 20 for tilt adjustment and the long hole 18 for telescopic adjustment. After the adjustment, the adjustment lever is rotated in a reverse direction to the predetermined direction, so that the interval between both the pressing parts is contracted. Thereby, the respective frictional forces are increased to keep the steering wheel 1 at a position after the adjustment.

According to the steering device as described above, the interval between both the pressing parts in the state where the interval between both the pressing parts is contracted by rotating the adjustment lever in the predetermined direction (the state where the respective frictional forces are increased) can be adjusted by adjusting a tightening amount of an adjustment nut screwed to a male screw portion provided to the adjustment rod, in the corresponding state.

Also, an axial force that is applied to the adjustment rod as the adjustment nut is tightened has an influence on the operating force of the adjustment lever and load that is caused when the outer column 12 is displaced forward relative to the inner column 13 upon secondary collision (an entire length of the steering column 6 is contracted).

In the meantime, in the related art, when assembling the steering device as described above, tightening amount adjustment of the adjustment nut is performed while checking the operating force of the adjustment lever, and the tightening amount adjustment of the adjustment nut is completed in a state where the checked operating force remains in a predetermined range. According to the assembling method of the related art, loss torque is unequally generated between the respective components upon the operation of the adjustment lever. Therefore, there is room for improvement from a standpoint of stabilizing the load that is caused when the outer column 12 is displaced forward relative to the inner column 13 upon the secondary collision. Also, according to the assembling method of the related art, there is room for improvement from a standpoint of stabilizing the keeping force in the telescopic position adjustment direction or the tilt position adjustment direction in the state where the steering wheel 1 is kept at the position after the adjustment.

When the improvements are accomplished, it is possible to stabilize shock absorption performance of a shock absorption mechanism configured to operate upon the secondary collision, to more securely protect the driver, and to stabilize the keeping force when keeping the steering wheel 1 at the position after the adjustment.

### CITATION LIST

### Patent Documents

Patent Document 1: Japanese Patent No. 4,178,318B

### SUMMARY OF THE INVENTION

### Problems to be Solved

The present invention provides a steering device and a method of assembling a steering device capable of stabilizing both an operating force of an adjustment lever and load that is caused when an outer column is displaced forward relative to an inner column upon secondary collision, and improving stabilization of a keeping force when keeping a steering wheel at a position after position adjustment.

### Means for Solving Problems

A steering device of the present invention includes a steering column, a displacement bracket, a displacement-side through-hole, a support bracket, a pair of vehicle body-side through-holes, an adjustment rod, a pair of pressing parts, and an adjustment lever.

The steering column is provided around a steering shaft configured to fix a steering wheel to an end portion thereof, and is configured to rotatably support the steering shaft. As a structure of the steering column, specifically, a structure where a cylindrical outer column is externally fitted to a cylindrical inner column to be relatively displaced in an axial direction and an entire length of the steering column can be thus expanded and contracted can be adopted.

Also, the displacement bracket is fixed to the outer column.

Also, the displacement-side through-hole is formed to penetrate the displacement bracket in a width direction. In a case where the steering device includes a telescopic mechanism for adjusting a position of the steering wheel in a front and rear direction, the displacement-side through-hole may be formed as a long hole for telescopic adjustment extending in the axial direction of the steering column.

Also, the support bracket includes a pair of support plate parts configured to sandwich the displacement bracket from both sides in the width direction, and is supported to a vehicle body.

Also, the pair of vehicle body-side through-holes is formed to penetrate the pair of support plate parts in the width direction at portions aligning with each other. In a case where the steering device includes a tilt adjustment mechanism for adjusting a vertical position of the steering wheel, the pair of vehicle body-side through-holes may be formed as long holes for tilt adjustment extending in the vertical direction.

Also, the adjustment rod is provided with being inserted in the displacement-side through-hole and the pair of vehicle body-side through-holes in the width direction.

Also, the pair of pressing parts is provided at portions, which are both end portions of the adjustment rod and protrude from outer surfaces of the pair of support plate parts.

Also, the adjustment lever is attached to the adjustment rod, and is configured to rotate about the adjustment rod, thereby expanding and contracting an interval between the pair of pressing parts.

Also, one of both the pressing parts is formed as an adjustment nut screwed to a male screw portion provided on the adjustment rod. When the adjustment lever is rotated in a predetermined direction, the interval between both the pressing parts can be adjusted.

In particular, a concave portion or a convex portion is formed at a central portion of at least one end surface of both axial end surfaces of the adjustment rod.

Also, concave portions may be formed at central portions of both axial end surfaces of the adjustment rod.

In the meantime, in a method of assembling the steering device as described above, the adjustment rod is inserted into the displacement-side through-hole and the pair of vehicle body-side through-holes in the width direction. The pair of pressing parts is provided at portions, which are both end portions of the adjustment rod and protrude from the outer surfaces of the pair of support plate parts (in the case of the adjustment nut that is one pressing part, the adjustment nut is screwed to the male screw portion). After attaching the adjustment lever to the adjustment rod, a tightening amount of the adjustment nut, which is the one pressing part, is adjusted while checking an axial force that is applied to the adjustment rod by tightening the adjustment nut, in a state where an interval between the pair of pressing parts is contracted by rotating the adjustment lever in a predetermined direction. The tightening amount adjustment of the adjustment nut is completed in a state where the checked axial force remains in a predetermined range.

When implementing the method of assembling a steering device, for example, the axial force that is applied to the adjustment rod may be checked by measuring an axial stretching amount of the adjustment rod, which is generated by tightening the adjustment nut.

That is, a mechanical relation is satisfied between the axial force applied to the adjustment rod and the axial stretching amount of the adjustment rod (Hooke's law). Accordingly, when the relation (Young's modulus of the adjustment rod, which is a proportional constant) is examined in advance by a test and the like, it is possible to check (obtain) the axial force applied to the adjustment rod from the measured axial stretching amount of the adjustment rod.

In the meantime, the above configuration includes an aspect where the tightening amount of the adjustment nut is adjusted while measuring the axial stretching amount of the adjustment rod and the tightening amount adjustment of the adjustment nut is completed in a state where the measured stretching amount remains in a predetermined range (a range corresponding to the predetermined range relating to the axial force).

Also, when implementing the method of assembling a steering device, for example, in a state where a probe having functions of transmitting and receiving an ultrasonic wave is in contact with an input-side end surface of one axial end portion of the adjustment rod, the ultrasonic wave transmitted from the probe may be input into the adjustment rod through the input-side end surface, and the axial stretching amount of the adjustment rod may be measured by receiving the ultrasonic wave reflected on a reflection-side end surface of the other axial end portion of the adjustment rod with the probe.

That is, for example, when a time after the probe transmits the ultrasonic wave until the probe receives the ultrasonic wave reflected on the reflection-side end surface (a time until the ultrasonic wave input into the adjustment rod through the input-side end surface is reflected on the reflection-side end surface and returns to the input-side end surface) is measured, it is possible to obtain an axial length from the input-side end surface to the reflection-side end surface on the basis of the measured time and a speed (a known value examined in advance) of the ultrasonic wave in the adjustment rod by a calculation. Accordingly, when a difference of the axial lengths before and after the stretching amount is generated is obtained, the stretching amount can be obtained.

Also, when implementing the method of assembling a steering device, for example, one end-side concave portion may be provided at a central portion of one axial end surface of the adjustment rod, and a bottom surface of the one end-side concave portion may be formed as the input-side end surface.

Alternatively, for example, one end-side convex portion may be provided at a central portion of one axial end surface of the adjustment rod, and a leading end surface of the one end-side concave portion may be formed as the input-side end surface.

For example, an outer diameter of the one end-side convex portion may be configured to be smaller than an outer diameter of the reflection-side end surface.

Also, for example, the other end-side concave portion may be provided at a central portion of the other axial end surface of the adjustment rod, and a bottom surface of the other end-side concave portion may be formed as the reflection-side end surface.

Alternatively, for example, the other end-side convex portion may be provided at a central portion of the other axial end surface of the adjustment rod, and a leading end surface of the other end-side convex portion may be formed as the reflection-side end surface.

Also, for example, the input-side end surface may be formed as a flat surface perpendicular to a central axis of the adjustment rod.

Alternatively, for example, the input-side end surface may be formed as a convex curved surface of which a central part most protrudes (for example, a spherical convex surface).

Also, for example, the reflection-side end surface may be formed as a flat surface perpendicular to a central axis of the adjustment rod.

Alternatively, for example, the reflection-side end surface may be formed as a convex curved surface of which a central part most protrudes (for example, a spherical convex surface).

Also, for example, the axial stretching amount of the adjustment rod may be measured by using a contact-type length measuring device (a micrometer, a dial gauge or the like).

Also, for example, the axial force applied to the adjustment rod may be checked by measuring a transmissivity of the ultrasonic wave radially penetrating the adjustment nut.

Also, for example, the axial end surface of the adjustment rod may be provided with a concave portion or a convex portion, and the axial stretching amount of the adjustment rod may be measured in a state where the concave portion or the convex portion and a part of the contact-type length measuring device are engaged with each other.

### Effects of the Invention

According to the method of assembling a steering device as described above, it is possible to stabilize both the operating force of the adjustment lever and the load that is caused when the outer column is displaced forward relative to the inner column upon secondary collision, and to improve stabilization of the keeping force when keeping the steering wheel at a position after position adjustment.

That is, the axial force that is applied to the adjustment rod as the adjustment nut is tightened has an influence on the operating force of the adjustment lever and the load that is caused when the outer column is displaced forward relative to the inner column upon the secondary collision. Regarding this, according to the present invention, the tightening amount of the adjustment nut is adjusted while checking the axial force applied to the adjustment rod, and the tightening amount adjustment of the adjustment nut is completed in the state where the checked axial force remains in the predetermined range. Accordingly, it is possible to stabilize both the operating force of the adjustment lever and the load that is caused when the outer column is displaced forward relative to the inner column upon the secondary collision, and to improve stabilization of the keeping force when keeping the steering wheel at the position after position adjustment.

### BRIEF DESCRIPTION OF THE DRAWINGS

FIG. 1 is a side view depicting a steering device, which is a target of an assembling method of a first example of an embodiment.

FIG. 2 is an enlarged sectional view taken along a line a-a of FIG. 1.

FIG. 3A is a sectional view depicting a situation of a test performed so as to examine a relation between an axial stretching amount of an adjustment rod and an axial force applied to the adjustment rod, and FIG. 3B is a line diagram depicting the relation.

FIG. 4 depicts an outer surface of a head part of an adjustment bolt.

FIG. 5A is a side view depicting a leading end portion of a rod part of an adjustment bolt, and FIGS. 5B and 5C are sectional views thereof.

FIG. 6 is an enlarged view relating to a second example of the embodiment and corresponding to a b part of FIG. 2.

FIG. 7 is a view similar to FIG. 6, depicting a state where a part is cut.

FIG. 8 is a view similar to FIG. 6, depicting a third example of the embodiment in a state where a probe is omitted and a part is cut.

FIG. 9 is a view similar to FIG. 6, depicting a fourth example of the embodiment in a state where the probe is omitted.

FIG. 10 is a view similar to FIG. 6, depicting a fifth example of the embodiment in a state where the probe is omitted.

FIG. 11 is a view similar to FIG. 6, depicting a sixth example of the embodiment.

FIG. 12 is a side view of the adjustment bolt, depicting a seventh example of the embodiment in a state where a part is cut.

FIG. 13A is a side view of the adjustment bolt and the probe, depicting an eighth example of the embodiment in a state where a part is cut, and FIG. 13B is an enlarged view of a c part of FIG. 13A.

FIG. 14 is a side view of the leading end portion of the rod part of the adjustment bolt, depicting a ninth example of the embodiment.

FIG. 15 is an enlarged view corresponding to a d part of FIG. 2, depicting a tenth example of the embodiment.

FIG. 16 is a view similar to FIG. 3A, depicting an eleventh example of the embodiment.

FIG. 17 is a view similar to FIG. 3A, depicting a twelfth example of the embodiment.

FIG. 18 is a view similar to FIG. 3A, depicting a thirteenth example of the embodiment.

FIG. 19A is a view corresponding to an e part of FIG. 18, and FIG. 19B is a top view of FIG. 19A.

FIGS. 20A and 20B are views similar to FIGS. 19A and 19B, depicting a first example of another example of a concave portion in accordance with the thirteenth example of the embodiment.

FIGS. 21A and 21B are views similar to FIGS. 19A and 19B, depicting a second example of another example of the concave portion in accordance with the thirteenth example of the embodiment.

FIG. 22 is a view similar to FIG. 3A, depicting a fourteenth example of the embodiment.

FIG. 23 is a partially cut side view depicting an example of a steering device having a tilt mechanism of the related art.

### DETAILED DESCRIPTION OF EMBODIMENTS

### First Example of Embodiment

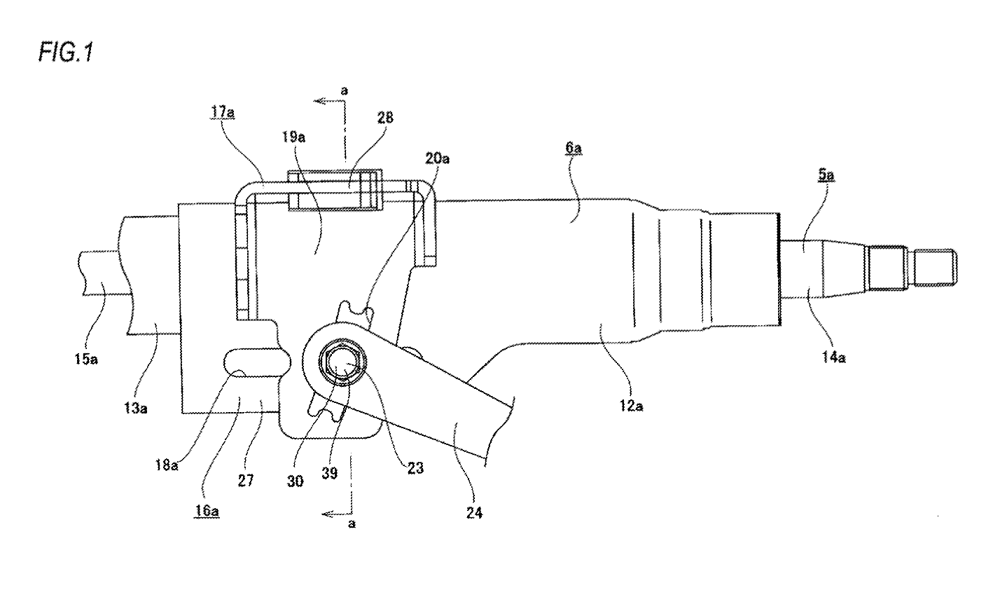

A first example of an embodiment is described with reference to FIGS. 1 to 5C.

A steering device, which is an object of an assembling method of the first example, includes a steering column 6a, a displacement bracket 16a, a steering shaft 5a, a support bracket 17a, an adjustment bolt 23 which is an adjustment rod, an adjustment lever 24, and an adjustment nut 25.

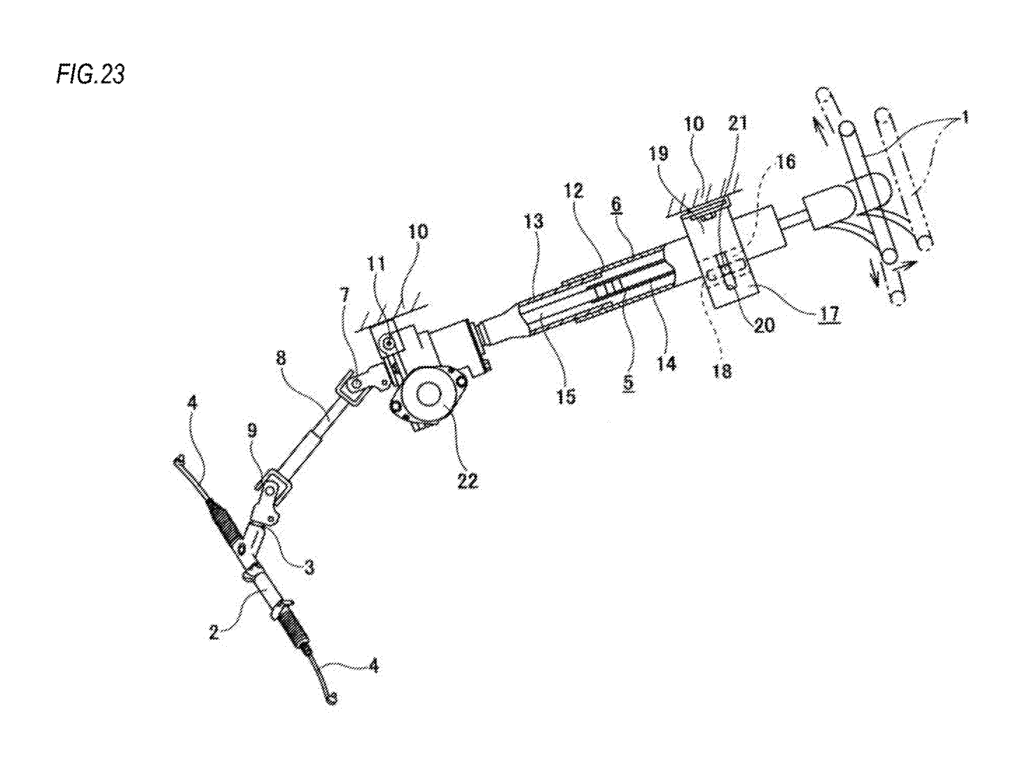

The steering column 6a is configured to expand and contract an entire length thereof by externally fitting a front part of a cylindrical outer column 12a arranged at a rear side to a rear part of a cylindrical inner column 13a arranged at a front side. Also, a lower end portion of a front half part of the outer column 12a is provided with a slit 26 extending in an axial direction and opening to a front end edge of the outer column 12a. Thereby, an inner diameter of the front half part of the outer column 12a can be elastically expanded and contracted. Also, a front end portion of the inner column 13a is supported to a vehicle body so that it can be swingably displaced about a pivot 11 (refer to FIG. 23) arranged in a width direction.

The displacement bracket 16a has a pair of clamped parts 27, 27. Both the clamped parts 27, 27 are provided integrally with the outer column 12a at positions, which are located near both ends of a lower surface of the front half part of the outer column 12a in the width direction and at which the slit 26 is sandwiched from both right and left sides. Also, both the clamped parts 27, 27 are formed at portions aligning with each other with long holes 18a, 18b for telescopic adjustment penetrating the portions in the width direction and elongated in the axial direction of the outer column 12a. In the first example, the long holes 18a, 18b for telescopic adjustment correspond to the displacement-side through-hole defined in the claims.

The steering shaft 5a has such a configuration that a front part of an outer shaft 14a arranged at a rear side and a rear part of an inner shaft 15a arranged at a front side are combined by spline engagement or the like so as to transmit torque and to be relatively displaced in the axial direction. A part near a rear end of an intermediate part of the outer shaft 14a is rotatably supported to a rear end portion of the outer column 12a by a rolling bearing. A part near a front end of an intermediate part of the inner shaft 15a is rotatably supported to a front end portion of the inner column 13a by a rolling bearing. The rolling bearings configured to support the part near the rear end of the intermediate part of the outer shaft 14a and the part near the front end of the intermediate part of the inner shaft 15a are rolling bearings capable of supporting radial load and thrust load, such as a ball bearing of a single-row deep groove ball type. Therefore, the steering shaft 5a is configured to be expanded and contracted as the steering column 6a is expanded and contracted. The steering wheel 1 (refer to FIG. 23) is supported and fixed to a rear end portion of the outer shaft 14a, which protrudes rearward beyond a rear end opening of the outer column 12a.

The support bracket 17a is configured by coupling a plurality of components each other, each of which is made of a metal plate having sufficient stiffness such as a steel plate, by welding or the like. Both end portions of an upper end portion of the support bracket 17a in the width direction have a pair of attachment plate parts 28, 28 for supporting the support bracket 17a to the vehicle body. Also, the support bracket 17a has a pair of flat plate-shaped support plate parts 19a, 19b hanging down from inner end portions of both the attachment plate parts 28, 28 in the width direction and parallel with each other. Also, both the support plate parts 19a, 19b are formed at potions aligning with each other with long holes 20a, 20b for tilt adjustment penetrating the portions in the width direction and elongated in the vertical direction. In the first example, both the long holes 20a, 20b for tilt adjustment have a circular arc shape of which a center is the pivot 11, respectively. The support bracket 17a formed as described above is supported to the vehicle body so that it can be detached forward by shock load, which is to be applied thereto upon secondary collision, in a state where both the support plate parts 19a, 19b are arranged at positions at which the displacement bracket 16a is sandwiched from both sides in the width direction. In the first example, the long holes 20a, 20b for tilt adjustment correspond to the vehicle body-side through-holes defined in the claims.

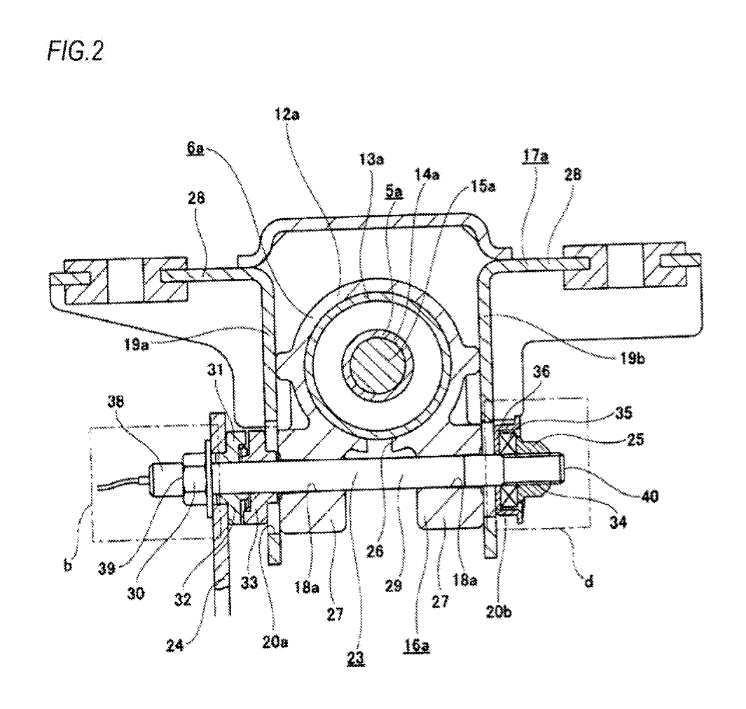

The adjustment bolt 23 is made of metal such as steel, and has a circular cylinder-shaped rod part 29 and a head part 30 formed integrally with a base end portion (a left end portion in FIG. 2) of the rod part 29 and having a diameter larger than the rod part 29. The rod part 29 is inserted in both the long holes 18a, 18b for telescopic adjustment and both the long holes 20a, 20b for tilt adjustment in the width direction.

A base end portion of the adjustment lever 24 is coupled and fixed to the base end portion of the rod part 29 of the adjustment bolt 23, which protrudes from an outer surface of one (left, in FIG. 2) support plate part 19a of both the support plate parts 19a, 19b in the width direction. A cam device 31 is provided between the outer surface of the one support plate part 19a in the width direction and the adjustment lever 24. The cam device 31 is configured to expand and contract an axial dimension on the basis of relative displacement between a drive-side cam 32 and a non-drive-side cam 33. The non-drive-side cam 33 is engaged with the long hole 20a for tilt adjustment formed in the one support plate part 19a so that it can be only displaced along the long hole 20a for tilt adjustment (rotation is prohibited). On the other hand, the drive-side cam 32 is configured to rotate together with the adjustment bolt 23 by the adjustment lever 24. Also, the adjustment nut 25 made of metal such as steel is screwed to a part, which protrudes from an outer surface of the other (right, in FIG. 2) support plate part 19b of both the support plate parts 19a, 19b in the width direction, of a male screw portion 34 formed at a leading end portion (a right end portion, in FIG. 2) of the rod part 29 of the adjustment bolt 23. A thrust bearing 35 and a pressing plate 36 are provided in corresponding order from the adjustment nut 25 between the outer surface of the other support plate part 19a in the width direction and the adjustment nut 25. An inner surface of the pressing plate 36 in the width direction is contacted and friction-engaged to the outer surface of the other support plate part 19b in the width direction. In the meantime, in the first example, the non-drive-side cam 33 and the adjustment nut 25 correspond to the pair of pressing parts defined in the claims.

When adjusting a position of the steering wheel 1 in the vertical direction or in the front and rear direction, the adjustment lever 24 is caused to swing in a predetermined direction (generally, downward). Thereby, the axial dimension of the cam device 31 is reduced, so that an interval between the non-drive-side cam 33 and the adjustment nut 25, which are the pair of pressing parts, is increased. Accompanied by this, the inner diameter of the front half part of the outer column 12a is elastically expanded. As a result, a frictional force that is applied to a contact part between an outer peripheral surface of the inner column 13a and an inner peripheral surface of the outer column 12a, a frictional force that is applied to contact parts between the outer surfaces of the pair of clamped parts 27, 27, which configures the displacement bracket 16a, in the width direction and the inner surfaces of the pair of support plate parts 19a, 19b, which configures the support bracket 17a, in the width direction, and a frictional force that is applied to contact parts between the outer surfaces of both the support plate parts in the width direction and the inner surfaces of the non-drive-side cam 33 and pressing plate 36 in the width direction are respectively reduced. In this state, a position of the steering wheel 1 is adjusted within a range in which the rod part 29 of the adjustment bolt 23 can be displaced in both the long holes 20a, 20b for tilt adjustment and both the long holes 18a, 18b for telescopic adjustment. After the adjustment, the adjustment lever 24 is caused to swing in a reverse direction (generally, upward) to the predetermined direction, so that the interval between the non-drive-side cam 33 and the adjustment nut 25 is decreased. Thereby, the respective frictional forces are increased, so that the steering wheel 1 is kept at a position after the adjustment.

When assembling the steering device as described above, as shown in FIGS. 1 and 2, in a state where the pair of support plate parts 19a, 19b is arranged at positions at which the displacement bracket 16a is sandwiched from both sides in the width direction, the rod part 29 of the adjustment bolt 23 is inserted into both the long holes 20a, 20b for tilt adjustment and both the long holes 18a, 18b for telescopic adjustment. Also, the base end portion of the adjustment lever 24, the cam device 31, the adjustment nut 25, the thrust bearing 35 and the pressing plate 36 are respectively attached to both end portions of the rod part 29, which protrude from the outer surfaces of both the support plate parts 19a, 19b in the width direction.

Then, in this state, when the adjustment lever 24 is rotated in the predetermined direction, the tightening amount of the adjustment nut 25 screwed to the male screw portion 34 of the adjustment bolt 23 is adjusted in the state where the interval between the non-drive-side cam 33 and the adjustment nut 25, which are the pair of pressing parts, is decreased. Thereby, the interval between the non-drive-side cam 33 and the adjustment nut 25 is adjusted.

Particularly, in the first example, the adjustment operation is performed while checking an axial force that is applied to the adjustment bolt 23 as the adjustment nut 25 is tightened. Then, the tightening amount adjustment of the adjustment nut 25 is completed in a state where the checked axial force remains in a predetermined range set in advance. In other words, in the first example, the tightening amount of the adjustment nut 25 is adjusted so that the axial force applied to the adjustment bolt 23 remains in the predetermined range set in advance, in a state where the steering wheel 1 can be kept at the position after the adjustment.

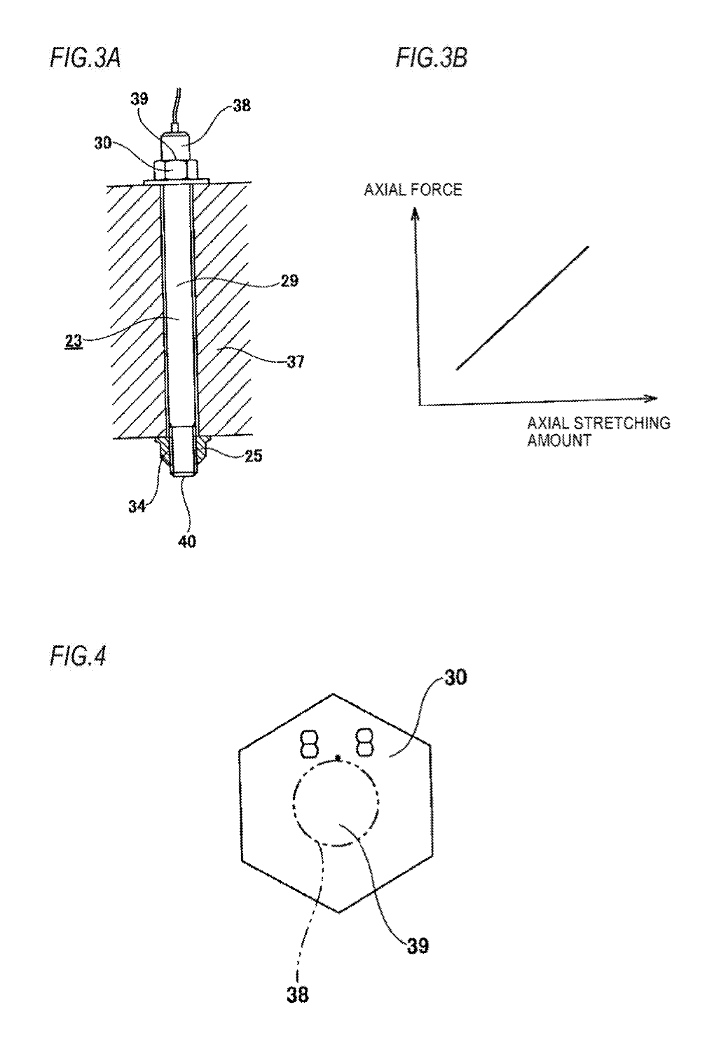

Also, in the first example, the axial force applied to the adjustment bolt 23 is checked by measuring an axial stretching amount of the adjustment bolt 23, which is caused by tightening the adjustment nut 25. That is, a mechanical relation as shown in FIG. 3B is satisfied between the axial force applied to the adjustment bolt 23 and the axial stretching amount of the adjustment bolt 23 (Hooke's law). Accordingly, for example, as shown in FIG. 3A, when the relation (Young's modulus of the adjustment bolt 23, which is a proportional constant) is examined in advance by performing a test or the like in a state where the adjustment bolt 23 and the adjustment nut 25 are attached to a testing machine 3, it is possible to obtain the axial force applied to the adjustment bolt 23 from the measured axial stretching amount of the adjustment bolt 23 by using the relation. In other words, it can be said that the measurement of the axial stretching amount of the adjustment bolt 23 is equivalent to the measurement of the axial force applied to the adjustment bolt 23. Therefore, in the first example, the tightening amount of the adjustment nut 25 is adjusted while measuring the axial stretching amount of the adjustment bolt 23, and the tightening of the adjustment nut 25 is completed in a state where the measured stretching amount remains in a predetermined range (a range corresponding to the predetermined range relating to the axial force). After the completion, the adjustment nut 25 is fixed to the male screw portion 34 by bonding the adjustment nut 25 to the male screw portion 34 or swaging and attaching a part of the adjustment nut 25 to the male screw portion 34, for example.

Also, in the first example, the axial stretching amount of the adjustment bolt 23 is measured with an ultrasonic wave. To this end, specifically, as shown in FIG. 2, a leading end surface (a right end surface, in FIG. 2) of a probe (ultrasonic wave probe) 38 having functions of transmitting and receiving an ultrasonic wave is contacted to a central portion of an outer surface 39 of the head part 30 of the adjustment bolt 23. In this state, an ultrasonic wave transmitted from the probe 38 is input into the adjustment bolt 23 through the outer surface 39 of the head part 30, and the ultrasonic wave reflected on a leading end surface 40 of the rod part 29 of the adjustment bolt 23 is received by the probe 38. At this time, a time after the probe 38 transmits the ultrasonic wave until the probe 38 receives the ultrasonic wave reflected on the leading end surface 40 of the rod part 29 (a time until the ultrasonic wave input into the adjustment bolt 23 through the outer surface 39 of the head part 30 of the bolt is reflected on the leading end surface 40 of the rod part 29 and returns to the outer surface 39 of the head part 30 of the bolt) is measured. Then, a length of the adjustment bolt 23 (an axial distance from the outer surface 39 of the head part 30 to the leading end surface 40 of the rod part 29) is obtained on the basis of the measured time and a speed (a known value examined in advance) of the ultrasonic wave in the adjustment bolt 23 by a calculation (the distance=the speed×(the measured time/2)).

In the first example, the length measurement of the adjustment bolt 23 is performed in a state before the adjustment nut 25 screwed to the male screw portion 34 is tightened (a state before the axial stretching amount is caused in the adjustment bolt 23), too. Then, a length difference of the adjustment bolt 23 before and after the axial stretching amount is generated in the adjustment bolt 23 is calculated to obtain the axial stretching amount of the adjustment bolt 23. Meanwhile, in the first example, the outer surface 39 of the head part 30 corresponds to the input-side end surface defined in the claims, and the leading end surface 40 of the rod part 29 corresponds to the reflection-side end surface defined in the claims.

Also, in the first example, the central portion, to which the leading end surface of the probe 38 is contacted, of the outer surface 39 of the head part 30 of the adjustment bolt 23 is formed as a flat surface with no unevenness perpendicular to a central axis of the adjustment bolt 23. That is, as shown in FIG. 4, in the case of diverse bolt products including the adjustment bolt 23, strength classification (character of “8.8”, in the shown example) of the bolt product is usually incused at a part near an outer periphery of the outer surface 39 of the head part 30, and the incused part is formed as an unevenness part. Regarding this, in the first example, the leading end surface of the probe 38 is contacted to the flat surface with no unevenness, which is located at the central portion of the outer surface 39 of the head part 30 deviating from the incused part and is perpendicular to the central axis of the adjustment bolt 23. Thereby, it is possible to precisely measure the reflected ultrasonic wave by the probe 38.

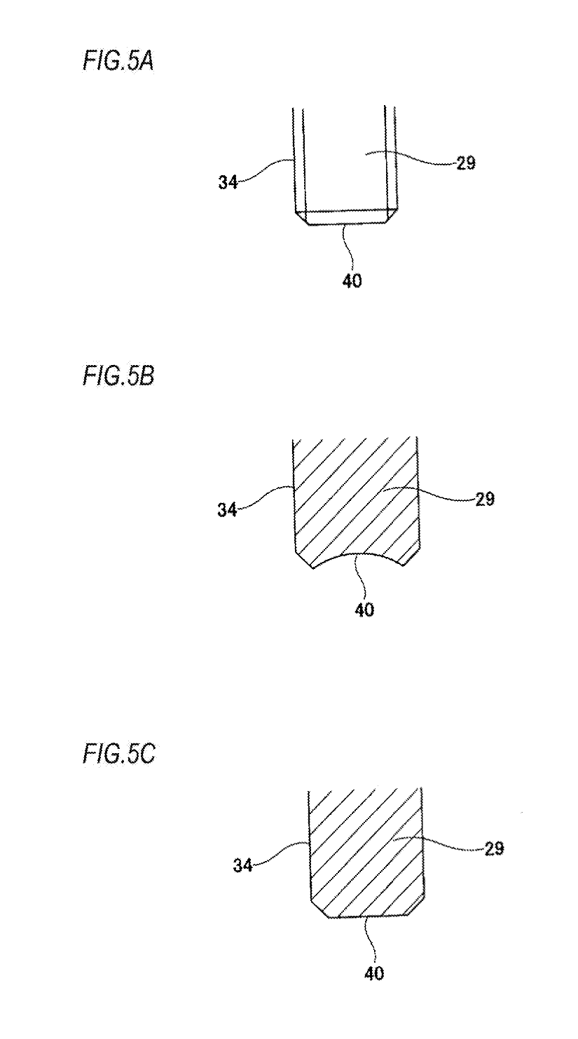

Also, in the first example, the leading end surface 40 of the rod part 29 of the adjustment bolt 23 is formed as a flat surface perpendicular to the central axis of the adjustment bolt 23, as shown in FIG. 5C. That is, in the case of diverse bolt products including the adjustment bolt 23, the leading end surface 40 of the rod part 29 usually looks as if it is a flat surface perpendicular to the central axis, as seen from a radially outer side, as shown in FIG. 5A. However, the leading end surface is actually formed as a fractured surface, considering the mass production. Specifically, as shown in FIG. 5B, the leading end surface is formed as a concave curved surface of which a central portion is concave. In contrast, in the first example, the leading end surface 40 of the rod part 29 is formed as a flat surface perpendicular to the central axis of the adjustment bolt 23 by plastic forming, cutting working or the like. Thereby, the ultrasonic wave colliding with the leading end surface 40 of the rod part 29 is efficiently reflected toward the probe 38, so that the reflected ultrasonic wave can be precisely measured by the probe 38.

According to the method of assembling a steering device as described above, it is possible to stabilize both the operating force of the adjustment lever 24 and load that is caused when the outer column 12a is displaced forward relative to the inner column 13a upon secondary collision.

That is, the axial force that is applied to the adjustment bolt 23 as the adjustment nut 25 is tightened has an influence on the operating force of the adjustment lever 24 and the load that is caused when the outer column 12a is displaced forward relative to the inner column 13a upon the secondary collision. Regarding this, in the first example, the tightening amount of the adjustment nut 25 is adjusted while checking the axial force applied to the adjustment bolt 23, and the tightening amount adjustment of the adjustment nut 25 is completed in the state where the checked axial force remains in the predetermined range. Accordingly, it is possible to stabilize both the operating force of the adjustment lever 24 and the load that is caused when the outer column 12a is displaced forward relative to the inner column 13a upon the secondary collision.

### Second Example of Embodiment

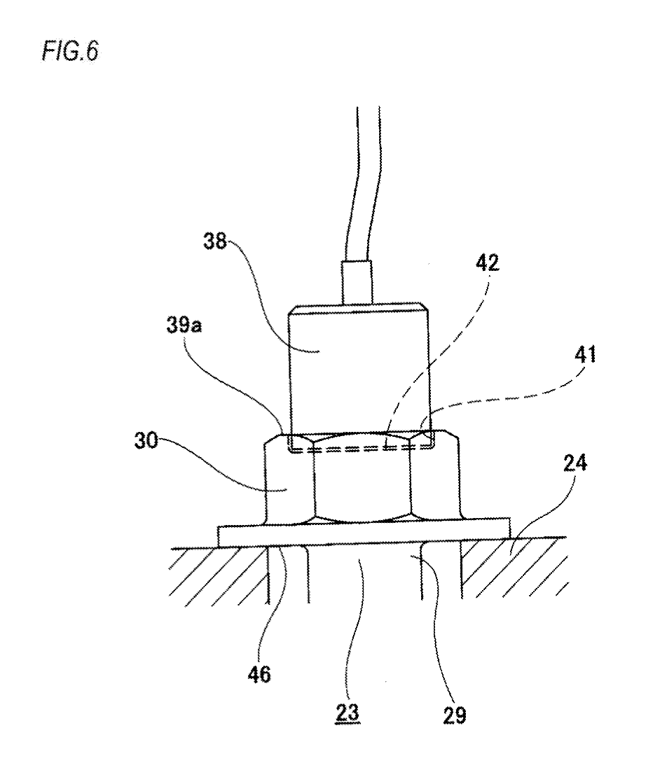

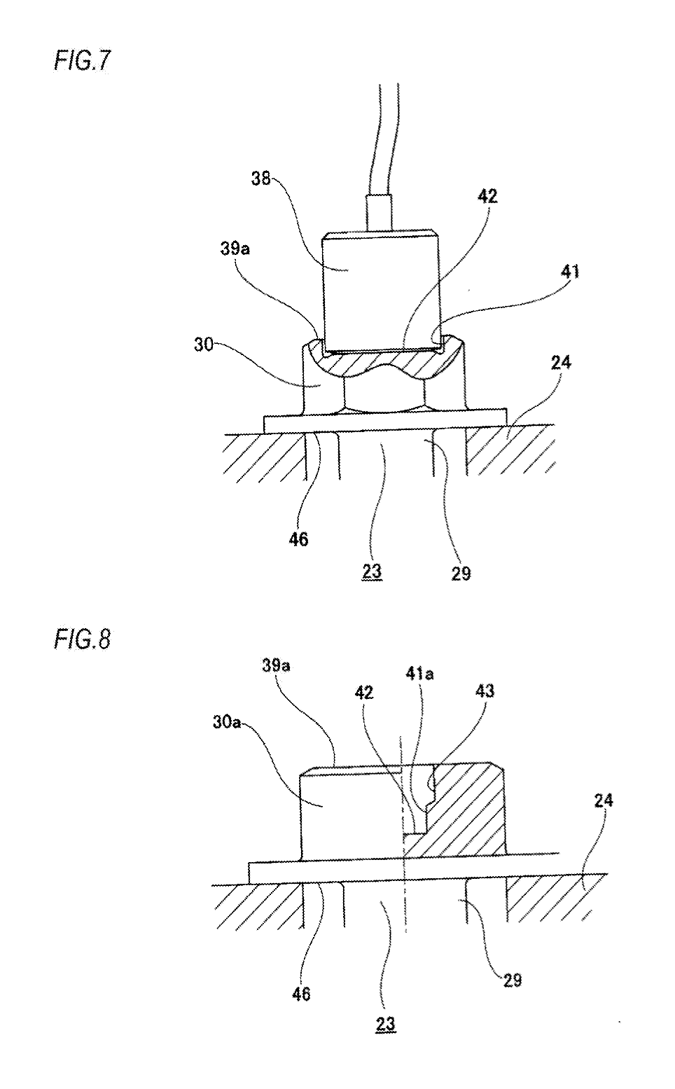

A second example of the embodiment is described with reference to FIGS. 6 and 7.

In the second example, a concave portion 41 is provided at a central portion of an outer surface 39a of the head part 30 of the adjustment bolt 23, and a part except at least an outer peripheral edge portion of a bottom surface 42 of the concave portion 41 is formed as a flat surface perpendicular to the central axis of the adjustment bolt 23. In the second example, the concave portion 41 has a circular shape, as seen from the axial direction. Meanwhile, in the second example, the concave portion 41 corresponds to the one end-side concave portion defined in the claims, and the part (flat surface) except at least the outer peripheral edge portion of the bottom surface 42 of the concave portion 41 corresponds to the input-side end surface defined in the claims.

In the second example, when measuring the axial stretching amount of the adjustment bolt 23, in a state where the leading end portion of the probe 38 is engaged (inserted) with the concave portion 41 and the leading end surface of the probe 38 is in contact with the bottom surface (flat surface) 42 of the concave portion 41, the ultrasonic wave is input into the adjustment bolt 23 through the bottom surface (flat surface) 42.

In the second example, since it is possible to determine a radial position of the probe 38 by the concave portion 41, it is possible to easily measure the axial stretching amount of the adjustment bolt 23. Also, since the counterpart surface to which the leading end surface of the probe 38 is contacted is configured with the bottom surface 42 of the concave portion 41, the counterpart surface (the bottom surface 42) is difficult to be scratched before the measurement of the stretching amount. Accordingly, it is possible to secure the measurement reliability of the stretching amount.

The other configurations and operations are similar to the first example of the embodiment.

### Third Example of Embodiment

A third example of the embodiment is described with reference to FIG. 8.

In the third example, a half portion, which is close to an outer surface 39a of a head part 30a, of a concave portion 41a provided at a central portion of the outer surface 39a of the head part 30a of the adjustment bolt 23 is formed as a hexagonal hole 43 for engaging therein a hexagonal wrench.

The other configurations and operations are similar to the second example of the embodiment.

### Fourth Example of Embodiment

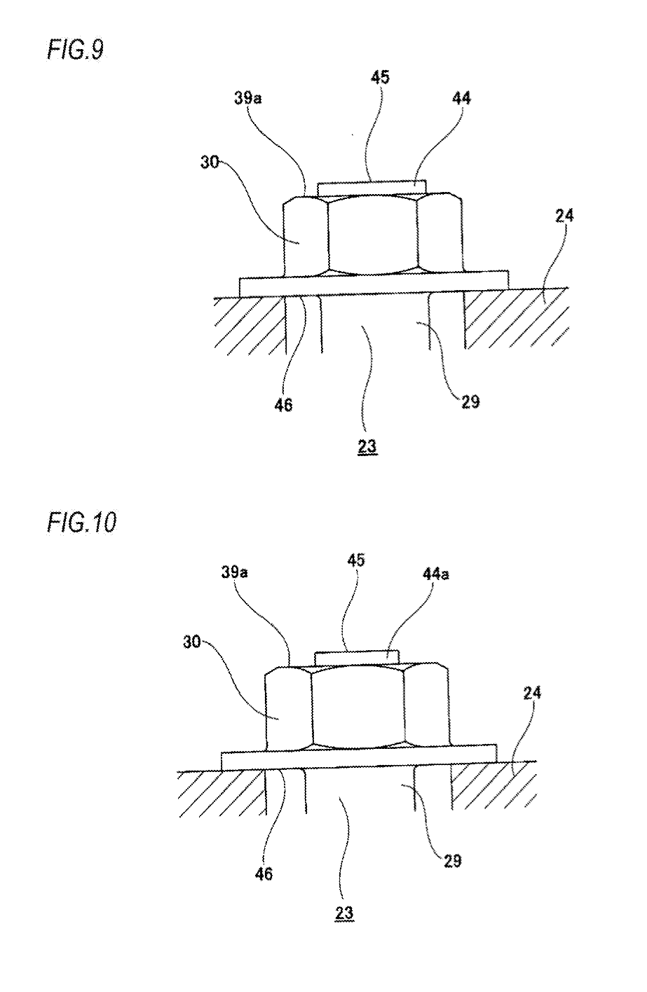

A fourth example of the embodiment is described with reference to FIG. 9.

In the fourth example, a convex portion 44 more protruding axially than a surrounding portion is provided at a central portion of the outer surface 39a of the head part 30 of the adjustment bolt 23, and a leading end surface 45 of the convex portion 44 is formed as a flat surface perpendicular to the central axis of the adjustment bolt 23. In the fourth example, the convex portion 44 has a circular shape, as seen from the axial direction. Meanwhile, in the fourth example, the convex portion 44 corresponds to the one end-side convex portion defined in the claims, and the leading end surface 45 of the convex portion 44 corresponds to the input-side end surface defined in the claims.

Also, in the fourth example, an outer diameter of the convex portion 44 is substantially the same as an outer diameter of the leading end surface 40 (for example, refer to FIG. 2) of the rod part 29 of the adjustment bolt 23, which is the reflection-side end surface.

In the fourth example, when measuring the axial stretching amount of the adjustment bolt 23, in a state where the leading end surface of the probe 38 (refer to FIGS. 1 and 2) is in contact with the leading end surface 45 of the convex portion 44, the ultrasonic wave is input into the adjustment bolt 23 through the leading end surface 45.

In the fourth example, when measuring the stretching amount, even though a contact position of the leading end surface of the probe 38 to the leading end surface 45 of the convex portion 44 slightly deviates in the radial direction, since a radial position of the leading end surface 45 of the convex portion 44, through which the ultrasonic wave passes, does not change, it is possible to precisely measure the stretching amount.

The other configurations and operations are similar to the first example of the embodiment.

### Fifth Example of Embodiment

A fifth example of the embodiment is described with reference to FIG. 10.

In the fifth example, an outer diameter of a convex portion 44a provided at the central portion of the outer surface 39a of the head part 30 of the adjustment bolt 23 is made smaller than an outer diameter of the leading end surface 40 (for example, refer to FIG. 2) of the rod part 29 of the adjustment bolt 23, which is the reflection-side end surface.

In the fifth example, it is possible to suppress a noise, which is caused as the ultrasonic wave input through the leading end surface 45 of the convex portion 44a by the probe 38 collides and is reflected on a part (for example, a left surface that is the inner surface (left surface) 46 of the head part 30) except for the leading end surface 40 (for example, refer to FIG. 2) of the rod part 29, which is the reflection-side end surface, of the surface of the adjustment bolt 23. Accordingly, it is possible to improve the measurement precision of the axial stretching amount of the adjustment bolt 23.

The other configurations and operations are similar to the fourth example of the embodiment.

### Sixth Example of Embodiment

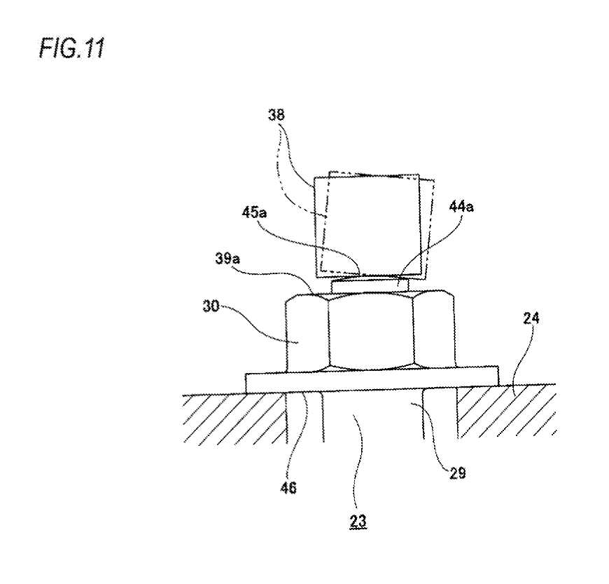

A sixth example of the embodiment is described with reference to FIG. 11.

In the sixth example, a leading end surface 45a of the convex portion 44a provided at the central portion of the outer surface 39a of the head part 30 of the adjustment bolt 23 is formed as a spherical convex surface, which is a convex curved surface of which a central portion most protrudes. Thereby, as shown with a dashed-dotted line in FIG. 11, even when a central axis of the probe 38 is slightly tilted relative to the central axis of the adjustment bolt 23, the contact state between the leading end surface of the probe 38 and the leading end surface 45a a of the convex portion 44a is kept.

The other configurations and operations are similar to the fourth and fifth examples of the embodiment.

### Seventh Example of Embodiment

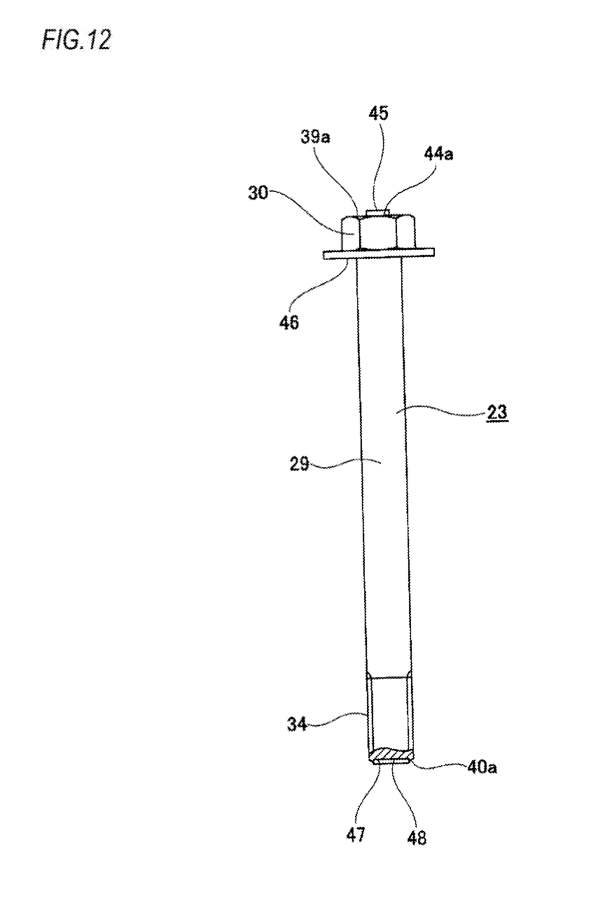

A seventh example of the embodiment is described with reference to FIG. 12.

In the seventh example, a concave portion 47 is provided at a central portion of a leading end surface 40a of the rod part 29 of the adjustment bolt 23, and a bottom surface 48 of the concave portion 47 is formed as a flat surface perpendicular to the central axis of the adjustment bolt 23. In the seventh example, the concave portion 47 has a circular shape, as seen from the axial direction. Meanwhile, in the seventh example, the concave portion 47 corresponds to the other end-side concave portion defined in the claims, and the bottom surface 48 of the concave portion 47 corresponds to the reflection-side end surface defined in the claims.

In the seventh example, the bottom surface 48 is formed as a reflection surface of the ultrasonic wave so as to measure the axial stretching amount of the adjustment bolt 23.

In the seventh example, since the reflection surface of the ultrasonic wave is formed by the bottom surface 48 of the concave portion 47, the reflection surface (the bottom surface 48) is difficult to be scratched before the measurement of the stretching amount. Therefore, it is possible to secure the measurement reliability of the stretching amount.

The other configurations and operations are similar to the first to sixth examples of the embodiment.

### Eighth Example of Embodiment

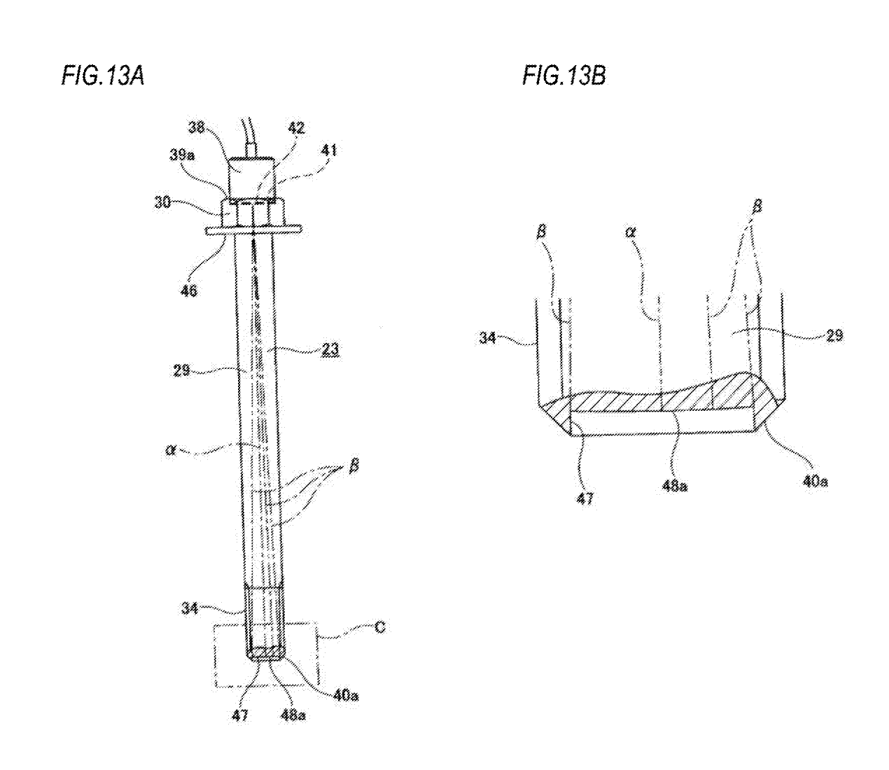

An eighth example of the embodiment is described with reference to FIGS. 13A and 13B.

In the case of measuring the axial stretching amount of the adjustment bolt 23 so as to implement the assembling method, when a posture of the probe 38 is tilted and a direction 62 of the ultrasonic wave to be input into the adjustment bolt 23 from the probe 38 is inclined relative to a central axis α of the adjustment bolt 23, the reflection of the ultrasonic wave is diffused in the adjustment bolt 23, so that an error of a measured value of the stretching amount of the adjustment bolt 23 may increase.

In the eighth example, in order to prevent the above problem, a bottom surface 48a of the concave portion 47 provided on the leading end surface 40a of the rod part 29 of the adjustment bolt 23, which is the reflection-side end surface, is formed as a spherical convex surface, which is a convex curved surface of which a central portion most protrudes toward the leading end surface 40a. Thereby, even when the direction β of the ultrasonic wave to be input into the adjustment bolt 23 from the probe 38 is inclined relative to the central axis α of the adjustment bolt 23, the ultrasonic wave colliding with the bottom surface 48a of the concave portion 47 can be efficiently reflected toward the probe 38. In the meantime, actually, since the ultrasonic wave is irradiated in a plane shape, the bottom surface 48a of the concave portion 47 is preferably formed as a spherical convex surface as wide as possible that reflects the ultrasonic wave irradiated in the plane shape.

The other configurations and operations are similar to the seventh example of the embodiment.

### Ninth Example of Embodiment

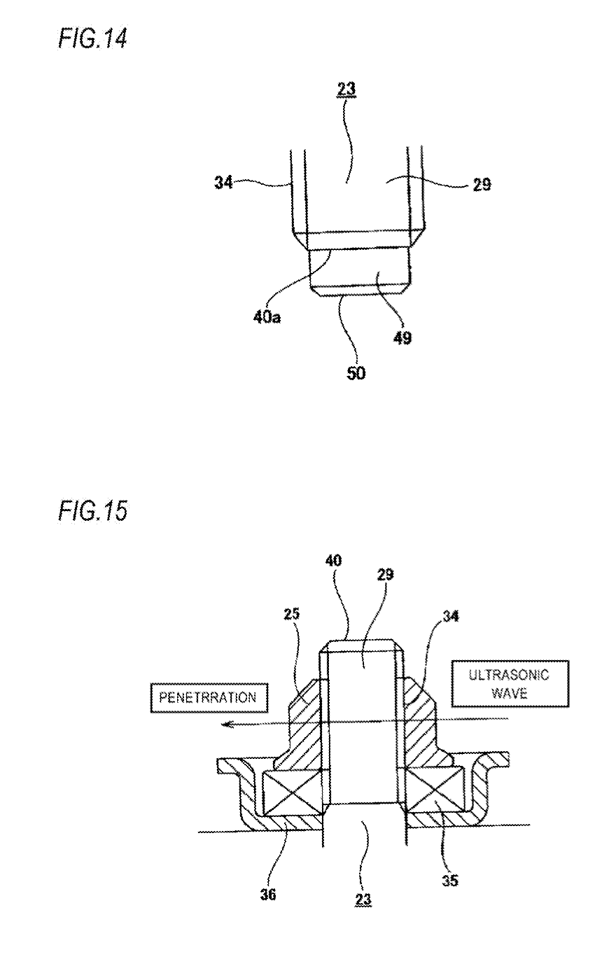

A ninth example of the embodiment is described with reference to FIG. 14.

In the ninth example, a convex portion 49 is provided at the central portion of the leading end surface 40a of the rod part 29 of the adjustment bolt 23, and a leading end surface 50 of the convex portion 49 is formed as a flat surface perpendicular to the central axis of the adjustment bolt 23. In the ninth example, the convex portion 49 has a circular shape, as seen from the axial direction. Meanwhile, in the ninth example, the convex portion 49 corresponds to the other end-side convex portion defined in the claims, and the leading end surface 50 of the convex portion 49 corresponds to the reflection-side end surface defined in the claims.

In the ninth example, the leading end surface 50 is formed as a reflection surface of the ultrasonic wave so as to measure the axial stretching amount of the adjustment bolt 23.

The other configurations and operations are similar to the first to sixth examples of the embodiment.

### Tenth Example of Embodiment

A tenth example of the embodiment is described with reference to FIG. 15.

Also in the tenth example, the tightening amount of the adjustment nut 25 screwed to the male screw portion 34 of the adjustment bolt 23 is adjusted while checking the axial force applied to the adjustment bolt 23. The tightening amount adjustment of the adjustment nut 25 is completed in a state where the checked axial force remains in the predetermined range.

Particularly, in the tenth example, the axial force applied to the adjustment bolt 23 is checked by enabling the ultrasonic wave to radially penetrate the adjustment nut 25 and measuring the transmissivity of the ultrasonic wave at that time. That is, a predetermined relation is satisfied between the axial force applied to the adjustment bolt 23 and the transmissivity of the ultrasonic wave. Accordingly, when the relation is examined in advance by a test and the like, it is possible to obtain the axial force applied to the adjustment bolt 23 from the measured transmissivity of the ultrasonic wave by using the relation. In other words, it can be said that the measurement of the transmissivity of the ultrasonic wave is equivalent to the measurement of the axial force applied to the adjustment bolt 23. Therefore, in the tenth example, the tightening amount of the adjustment nut 25 is adjusted while measurement the transmissivity of the ultrasonic wave, and the tightening amount adjustment of the adjustment nut 25 is completed in a state where the measured transmissivity of the ultrasonic wave remains in a predetermined range (a range corresponding to the predetermined range relating to the axial force).

The other configurations and operations are similar to the first example of the embodiment.

In the meantime, when implementing the present invention, the respective embodiments can be appropriately combined. For example, when measuring the axial stretching amount of the adjustment bolt 23 by a method similar to the first example of the embodiment, the shape shown in any one of the second to sixth examples of the embodiment may be adopted as the shape of the head part 30 of the adjustment bolt 23, and the shape shown in any one of the seventh to ninth examples of the embodiment may be adopted as the shape of the leading end portion of the rod part 29 of the adjustment bolt 23.

### Eleventh Example of Embodiment

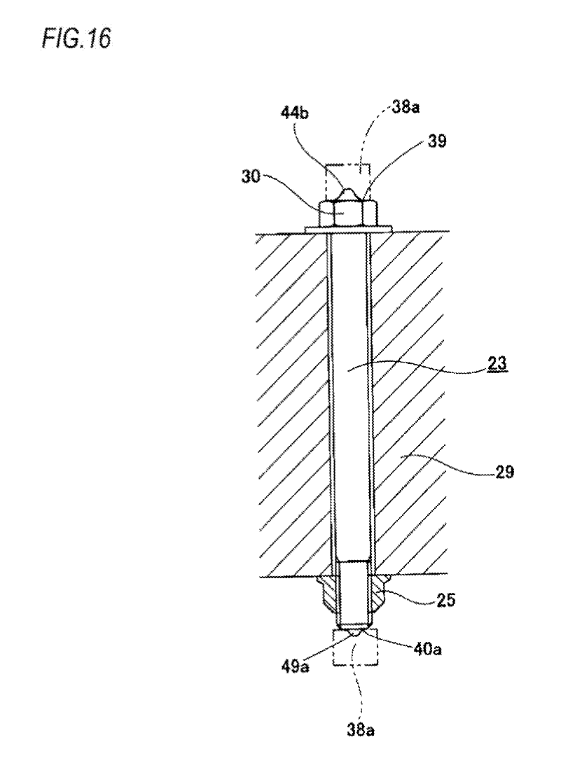

An eleventh example of the embodiment is described with reference to FIG. 16.

In the eleventh example, a convex portion 44b of which a sectional shape taken along a virtual plane (the drawing sheet of FIG. 16) passing the central axis of the adjustment bolt 23 is a substantially triangular shape is formed at the central portion of the outer surface 39a of the head part 30 of the adjustment bolt 23. Also, in the eleventh example, the convex portion 44b has a circular shape, as seen from the axial direction. That is, an outer surface of the convex portion 44b has a circular cone shape.

In the meantime, a convex portion 49a of which a sectional shape taken along the virtual plane passing the central axis of the adjustment bolt 23 is a substantially triangular shape is formed at the central portion of the leading end surface 40a of the rod part 29 of the adjustment bolt 23. Also, in the eleventh example, the convex portion 49a has a circular shape, as seen from the axial direction. That is, an outer surface of the convex portion 49a has a circular cone shape.

In the eleventh example, for example, the axial stretching amount of the adjustment bolt 23 is measured in a state where the leading end portion of the probe 38a of a contact-type length measuring device such as a micrometer and a dial gauge is engaged with the convex portion 44b and the convex portion 49a. On the other hand, the axial stretching amount of the adjustment bolt 23 may also be measured in a state where the leading end surface of the probe 38a is formed as a flat surface and is in contact (engagement) with the convex portion 44b and the convex portion 49a.

In the eleventh example, since the measurement can be performed in the state where the concave portion formed at the leading end portion of the probe 38a of the contact-type length measuring device is engaged with the convex portion 44a and the convex portion 49a, it is possible to easily perform the positioning and centering of the probe 38a and the adjustment bolt 23. In the meantime, for example, when the measurement is performed in a state where only one of the outer surface 39a of the head part 30 of the adjustment bolt 23 and the leading end surface 40a of the rod part 29 of the adjustment bolt 23 is in contact with the probe of the contact-type measuring device, the convex portion may be provided only on the one surface. The other configurations and operations are similar to the first example of the embodiment.

### Twelfth Example of Embodiment

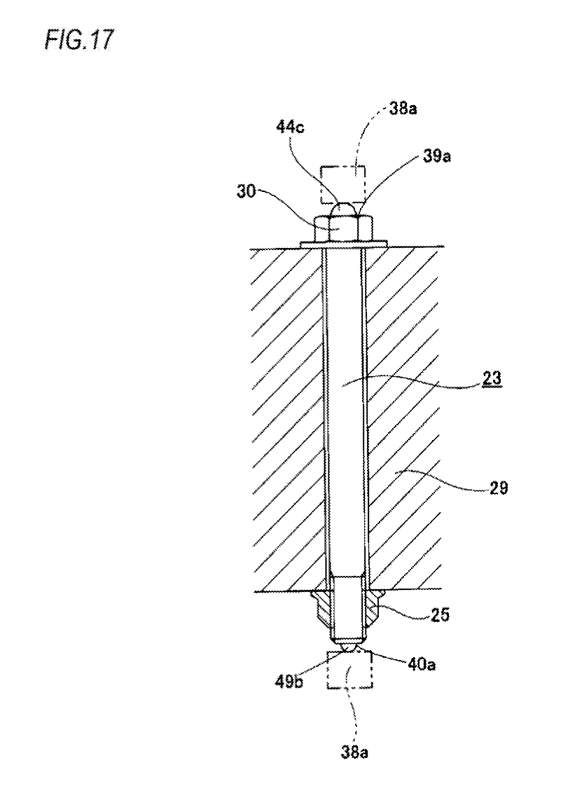

A twelfth example of the embodiment is described with reference to FIG. 17.

In the twelfth example, a convex portion 44c of which a sectional shape taken along a virtual plane (the drawing sheet of FIG. 17) passing the central axis of the adjustment bolt 23 is a semicircular shape is formed at the central portion of the outer surface 39a of the head part 30 of the adjustment bolt 23. Also, in the twelfth example, the convex portion 44c has a circular shape, as seen from the axial direction. That is, an outer surface of the convex portion 44c has a spherical shape.

In other words, the convex portion 44c is formed at the central portion of the outer surface 39a of the head part 30 of the adjustment bolt 23, as a hemisphere shape protruding from the outer surface 39a.

In the meantime, a convex portion 49b of which a sectional shape taken along the virtual plane passing the central axis of the adjustment bolt 23 is a semicircular shape is formed at the central portion of the leading end surface 40a of the rod part 29 of the adjustment bolt 23. Also, in the twelfth example, the convex portion 49b has a circular shape, as seen from the axial direction. That is, an outer surface of the convex portion 49b has a spherical shape.

In other words, the convex portion 49b is formed at the central portion of the leading end surface 40a of the rod part 29 of the adjustment bolt 23, as a hemisphere shape protruding from the leading end surface 40a.

In the twelfth example, for example, the axial stretching amount of the adjustment bolt 23 is measured in a state where the flat surface of the leading end portion of the probe of a contact-type length measuring device such as a micrometer and a dial gauge is in contact (engagement) with the convex portion 44c and the convex portion 49b. The other configurations and operations are similar to the first and eleventh examples of the embodiment.

### Thirteenth Example of Embodiment

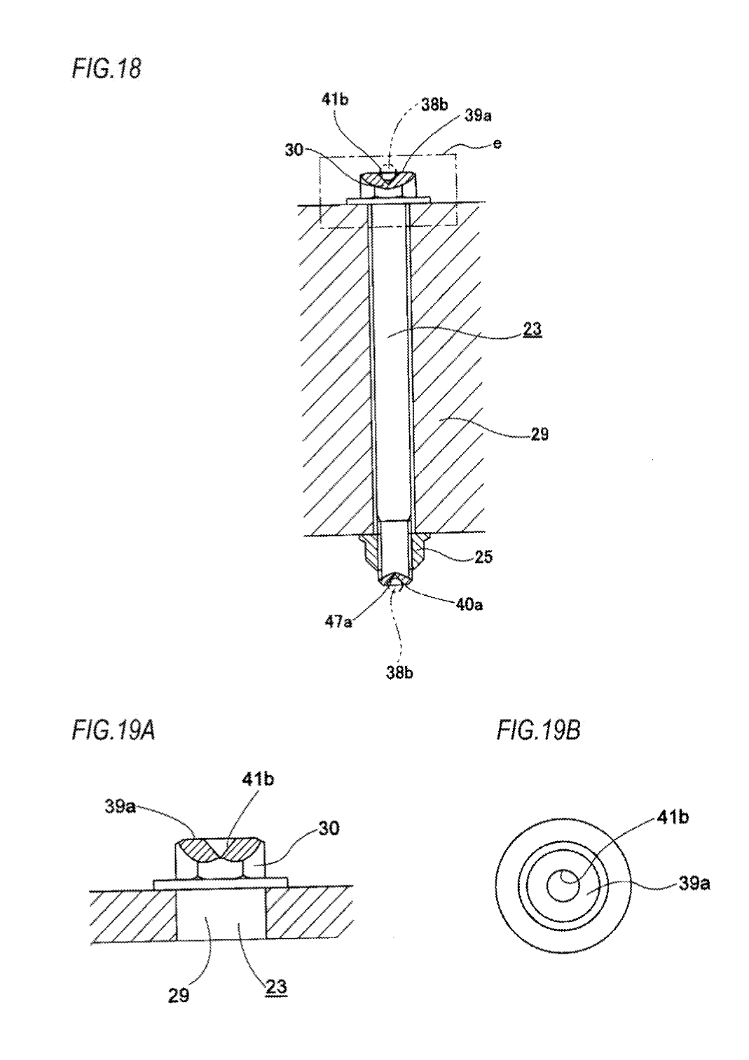

A thirteenth example of the embodiment is described with reference to FIGS. 18 to 19B.

In the thirteenth example, a concave portion 41b of which a sectional shape taken along a virtual plane (the drawing sheet of FIG. 18) passing the central axis of the adjustment bolt 23 is a substantially triangular shape is formed at the central portion of the outer surface 39a of the head part 30 of the adjustment bolt 23. Also, in the thirteenth example, the concave portion 41b has a circular shape, as seen from the axial direction. That is, an inner surface of the concave portion 41b has a circular cone shape.

In the meantime, a concave portion 47a of which a sectional shape taken along the virtual plane passing the central axis of the adjustment bolt 23 is a substantially triangular shape is formed at the central portion of the leading end surface 40a of the rod part 29 of the adjustment bolt 23. Also, in the thirteenth example, the concave portion 47a has a circular shape, as seen from the axial direction. That is, an inner surface of the concave portion 47a has a circular cone shape.

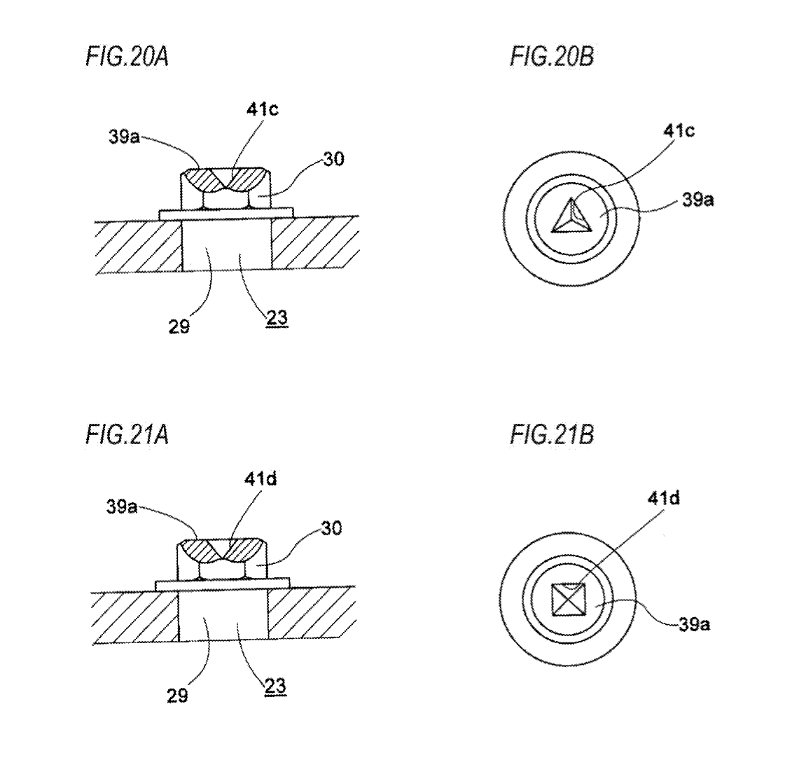

In the meantime, as the shape of the concave portion that is to be formed at the central portion of the outer surface 39a of the head part 30 of the adjustment bolt 23, a concave portion 41c shown in FIGS. 20A and 20B may be adopted, for example.

Specifically, a sectional shape of the concave portion 41c taken along a virtual plane (the drawing sheet of FIGS. 20A and 20B) passing the central axis of the adjustment bolt 23 is a substantially triangular shape. Also, the concave portion 41c has a triangular shape, as seen from the axial direction. That is, an inner surface of the concave portion 41c has a triangular pyramid shape. Although not shown, the shape of the concave portion 41c may be applied to the concave portion that is to be formed at the central portion of the leading end surface 40a of the rod part 29 of the adjustment bolt 23.

Also, as the shape of the concave portion that is to be formed at the central portion of the outer surface 39a of the head part 30 of the adjustment bolt 23, a concave portion 41d shown in FIGS. 21A and 21B may be adopted.

Specifically, a sectional shape of the concave portion 41d taken along the virtual plane (the drawing sheet of FIGS. 21A and 21B) passing the central axis of the adjustment bolt 23 is a substantially triangular shape. Also, the concave portion 41d has a quadrangular shape, as seen from the axial direction. That is, an inner surface of the concave portion 41d has a quadrangular pyramid shape. Although not shown, the shape of the concave portion 41d may be applied to the concave portion that is to be formed at the central portion of the leading end surface 40a of the rod part 29 of the adjustment bolt 23.

In the thirteenth example configured as described above, for example, the axial stretching amount of the adjustment bolt 23 is measured in a state where the leading end portion of the probe of a contact-type length measuring device such as a micrometer and a dial gauge is engaged with the concave portion 41b and the concave portion 47a.

In the thirteenth example configured as described above, including the structures of the other examples shown in FIGS. 20A to 21B, since the measurement can be performed in the state where a leading end portion of a probe 38b of the contact-type length measuring device is engaged with the concave portion 41b and the concave portion 47a, it is possible to easily perform the positioning and centering of the probe 38b and the adjustment bolt 23. Particularly, in the thirteenth example, since the sectional shapes of the concave portion 41b and the concave portion 47a taken along the virtual plane passing the central axis of the adjustment bolt 23 are the triangular shapes, it is possible to easily perform the positioning and centering of the probe 38b and the adjustment bolt 23 with respect to the contact-type length measuring device where a ball is provided to the leading end portion of the probe 38b. In the meantime, for example, when the measurement is performed in a state where only one of the outer surface 39a of the head part 30 of the adjustment bolt 23 and the leading end surface 40a of the rod part 29 of the adjustment bolt 23 is in contact with the probe of the contact-type measuring device, the concave portion may be provided only on the one surface. The other configurations and operations are similar to the first example of the embodiment.

### Fourteenth Example of Embodiment

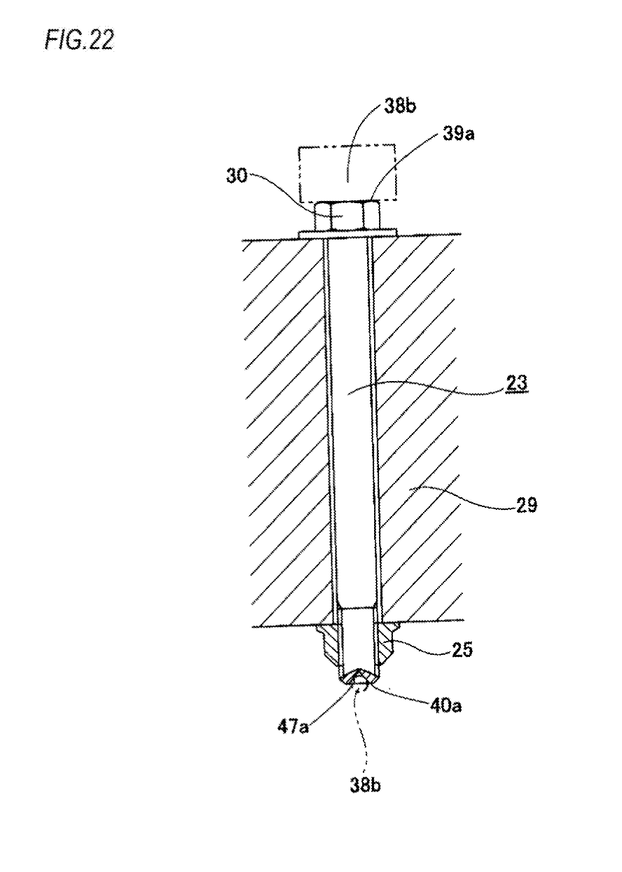

A fourteenth example of the embodiment is described with reference to FIG. 22.

In the fourteenth example, the central portion of the outer surface 39a of the head part 30 of the adjustment bolt 23 is not formed with the convex portion 44b of the eleventh example of the embodiment or the concave portion 41b of the thirteenth example.

On the other hand, the central portion of the leading end surface 40a of the rod part 29 of the adjustment bolt 23 is formed with a concave portion 47a of which a sectional shape taken along the virtual plane passing the central axis of the adjustment bolt 23 is a substantially triangular shape. Also, in the fourteenth example, the concave portion 47a has a circular shape, as seen from the axial direction. That is, an inner surface of the concave portion 47a has a circular cone shape.

In the fourteenth example, for example, a leading end surface of one (the upper, in FIG. 22) probe 38b of a pair of probes 38b, 38b of a contact-type length measuring device such as a micrometer and a dial gauge is formed as a flat surface, the flat surface is in contact with the outer surface 39a of the head part 30 of the adjustment bolt 23, the other (the lower, in FIG. 22) probe 38b has a ball provided at the leading end portion, and the axial stretching amount of the adjustment bolt 23 is measured in a state where the ball is engaged with the concave portion 47a. In the meantime, when implementing the measuring method of the fourteenth example, the concave portion 41b shown in the thirteenth example of the embodiment may be formed at the central portion of the outer surface 39a of the head part 30 of the adjustment bolt 23. The other configurations and operations are similar to the first example of the embodiment.

The subject application is based on Japanese Patent Application Nos. 2015-221901 filed on Nov. 12, 2015 and 2015-251205 filed on Dec. 24, 2015, the contents of which are incorporated herein by reference.

### INDUSTRIAL APPLICABILITY

The steering device of the present invention may be configured to have only the telescopic mechanism without the tilt mechanism or may be configured to have only the tilt mechanism without the telescopic mechanism. In this case, the through-holes formed to penetrate the pair of support plate parts, which configure the support bracket, in the width direction are formed as simple circular holes, for example.

Also, when implementing the present invention, the adjustment rod may be configured by a stud having male screw portions formed on both axial end portions.

Also, when implementing the present invention, the axial stretching amount of the adjustment rod may be measured by using a contact-type length measuring device such as a micrometer and a dial gauge.

Also, when implementing the present invention and measuring the axial stretching amount of the adjustment bolt by using the ultrasonic wave, the leading end surface of the probe configured to transmit and receive the ultrasonic wave may be contacted to the leading end surface (including the bottom surface of the concave portion or the leading end surface of the convex portion provided at the central portion of the leading end surface) of the rod part of the adjustment bolt.

Also, when implementing the present invention, as a modified embodiment of the structure shown in FIG. 2, a structure may be adopted in which the thrust bearing 35 and the pressing plate 36 are omitted and a thrust bearing is provided between the inner surface of the head part 30 of the adjustment bolt 23 in the width direction and the outer surface of the adjustment lever 24 in the width direction so as to enable the adjustment lever 24 and the drive-side cam 32 to rotate relative to the adjustment bolt 23, thereby preventing the adjustment bolt 23 from being rotated upon the rotation of the adjustment lever 24.

### DESCRIPTION OF REFERENCE NUMERALS

1: steering wheel
2: steering gear unit
3: input shaft
4: tie-rod
5, 5a: steering shaft
6, 6a: steering column
7: universal joint
8: intermediate shaft
9: universal joint
10: vehicle body
11: pivot
12, 12a: outer column
13, 13a: inner column
14, 14a: outer shaft
15, 15a: inner shaft
16, 16a: displacement bracket
17, 17a: support bracket
18, 18a: long hole for telescopic adjustment
19, 19a, 19b: support plate part
20, 20a, 20b: long hole for tilt adjustment
21: adjustment rod
22: electric motor
23: adjustment bolt
24: adjustment lever
25: adjustment nut
26: slit
27: clamped part
28: attachment plate part
29: rod part
30, 30a: head part
31: cam device
32: drive-side cam
33: non-drive-side cam
34: male screw portion
35: thrust bearing
36: pressing plate
37: testing machine
38, 38a, 38b: probe
39, 39a: outer surface
40, 40a: leading end surface
41, 41a, 41b, 41c: concave portion
42: bottom surface
43: hexagonal hole
44, 44a, 44b, 44c: convex portion
45, 45a: leading end surface
46: inner surface
47, 47a: concave portion
48, 48a: bottom surface
49, 49a, 49b: convex portion
50: leading end surface

1. A steering device comprising:
a steering column provided around a steering shaft configured to fix a steering wheel to an end portion thereof, and configured to rotatably support the steering shaft;
a displacement bracket fixed to a part of the outer column;
a displacement-side through-hole provided to the displacement bracket with penetrating the displacement bracket in a width direction;
a support bracket comprising a pair of support plate parts configured to sandwich the displacement bracket from both sides in the width direction, and supported to a vehicle body;
a pair of vehicle body-side through-holes provided at aligning portions of the pair of support plate parts with penetrating the pair of support plate parts in the width direction;
an adjustment rod provided with being inserted in the displacement-side through-hole and the pair of vehicle body-side through-holes in the width direction;
a pair of pressing parts provided at portions, which are both end portions of the adjustment rod and protrude from outer surfaces of the pair of support plate parts, and
an adjustment lever attached to the adjustment rod and configured to rotate about the adjustment rod, thereby expanding and contracting an interval between the pair of pressing parts,
wherein at least one through-hole of the displacement-side through-hole and the pair of vehicle body-side through-holes is elongated in a position adjustment direction, which is a direction in which a position of the steering wheel can be adjusted,
wherein one of both the pressing parts is an adjustment nut screwed to a male screw portion provided on the adjustment rod,
wherein when the adjustment lever is rotated in a predetermined direction, the interval between both the pressing parts can be adjusted, and
wherein a central portion of at least one of both axial end surfaces of the adjustment rod is formed with a concave portion of which a sectional shape taken along a virtual plane passing a central axis of the adjustment rod is a substantially triangular shape.

2. A steering device according to claim 1,
wherein concave portions are formed at central portions of both axial end surfaces of the adjustment rod.

3. A method of assembling a steering device, the steering device comprising:
a steering column provided around a steering shaft configured to fix a steering wheel to an end portion thereof, and configured to rotatably support the steering shaft;
a displacement bracket fixed to a part of the outer column;
a displacement-side through-hole provided to the displacement bracket with penetrating the displacement bracket in a width direction;
a support bracket comprising a pair of support plate parts configured to sandwich the displacement bracket from both sides in the width direction, and supported to a vehicle body;
a pair of vehicle body-side through-holes provided at aligning portions of the pair of support plate parts with penetrating the pair of support plate parts in the width direction;
an adjustment rod provided with being inserted in the displacement-side through-hole and the pair of vehicle body-side through-holes in the width direction;
a pair of pressing parts provided at portions, which are both end portions of the adjustment rod and protrude from outer surfaces of the pair of support plate parts, and
an adjustment lever attached to the adjustment rod and configured to rotate about the adjustment rod, thereby expanding and contracting an interval between the pair of pressing parts,
wherein at least one through-hole of the displacement-side through-hole and the pair of vehicle body-side through-holes is elongated in a position adjustment direction, which is a direction in which a position of the steering wheel can be adjusted,
wherein one of both the pressing parts is an adjustment nut screwed to a male screw portion provided on the adjustment rod,
wherein when the adjustment lever is rotated in a predetermined direction, the interval between both the pressing parts can be adjusted, and
wherein the method comprising:
inserting the adjustment rod into the displacement-side through-hole and the pair of vehicle body-side through-holes in the width direction;
providing the pair of pressing parts at portions, which are both end portions of the adjustment rod and protrude from the outer surfaces of the pair of support plate parts;
attaching the adjustment lever to the adjustment rod;
adjusting a tightening amount of the adjustment nut, which is the one pressing part, while checking an axial force that is applied to the adjustment rod by tightening the adjustment nut, in a state where an interval between the pair of pressing parts is contracted by rotating the adjustment lever in a predetermined direction, and
completing the tightening amount adjustment of the adjustment nut in a state where the checked axial force remains in a predetermined range,
wherein the axial force that is applied to the adjustment rod is checked by measuring an axial stretching amount of the adjustment rod, which is generated by tightening the adjustment nut,
wherein the axial end surface of the adjustment rod is provided with a concave portion of which a sectional shape taken along a virtual plane passing a central axis of the adjustment rod is a substantially triangular shape, and
wherein the axial stretching amount of the adjustment rod is measured in a state where the concave portion and a part of a contact-type length measuring device are engaged with each other.

4-14. (canceled)

15. The method of assembling a steering device according to claim 3,
wherein the axial stretching amount of the adjustment rod is measured by using the contact-type length measuring device.

16-17. (canceled)
